(19) United States
(12) Patent Application Publication
(10) Pub. No.: US 2017/0119151 A1
(43) Pub. Date: May 4, 2017

(54) TRANSPARENT GARMENT RECEPTACLE

(71) Applicant: CAROL BARBER, WEEKI WACHEE, FL (US)

(72) Inventor: CAROL BARBER, WEEKI WACHEE, FL (US)

(21) Appl. No.: 14/930,877

(22) Filed: Nov. 3, 2015

(51) Int. Cl. A47B 61/00; A47B 95/00; A47B 96/02; G09F 3/20; A47B 96/20; A47B 97/00; A47G 1/06; F16B 47/00; A47F 3/12

(52) U.S. Cl. CPC A47B 61/003; F16B 47/003; A47B 95/00; A47B 96/02; A47F 3/125; A47B 96/20; A47B 97/00; A47G 1/06; G09F 3/204; F16B 2001/0028

(57) ABSTRACT

The transparent garment receptacle is cabinet that hangs within a closet from hangar rods. The transparent garment receptacle is made from a transparent material. The transparent garment receptacle further comprises a plurality of shelves. Each of the plurality of shelves had a transparent door mounted in front of the shelf. A picture frame is mounted on the exterior surface of each transparent door such that a picture placed in the picture frame is visible from the exterior or the transparent garment receptacle. The transparent garment receptacle comprises a shell, a plurality of shelves, a plurality of doors, a first fastener, and a second fastener.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of cabinets and cabinetry, more specifically, a transparent cabinet designed to hang in a closet.

### SUMMARY OF INVENTION

The transparent garment receptacle is cabinet that hangs within a closet from hangar rods. The transparent garment receptacle is made from a transparent material. The transparent garment receptacle further comprises a plurality of shelves. Each of the plurality of shelves had a transparent door mounted in front of the shelf. A picture frame is mounted on the exterior surface of each transparent door such that a picture placed in the picture frame is visible from the exterior or the transparent garment receptacle.

These together with additional objects, features and advantages of the transparent garment receptacle will be readily apparent to those of ordinary skill in the art upon reading the following detailed description of the presently preferred, but nonetheless illustrative, embodiments when taken in conjunction with the accompanying drawings.

In this respect, before explaining the current embodiments of the transparent garment receptacle in detail, it is to be understood that the transparent garment receptacle is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the transparent garment receptacle.

It is therefore important that the claims be regarded as including such equivalent construction insofar as they do not depart from the spirit and scope of the transparent garment receptacle. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front perspective view of an embodiment of the disclosure.

FIG. 2 is a rear perspective view of an embodiment of the disclosure.

FIG. 3 is a front view of an embodiment of the disclosure.

FIG. 4 is a detail view of an embodiment of the disclosure.

FIG. 5 is a cross-sectional view of an embodiment of the disclosure across 5-5 in FIG. 3.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

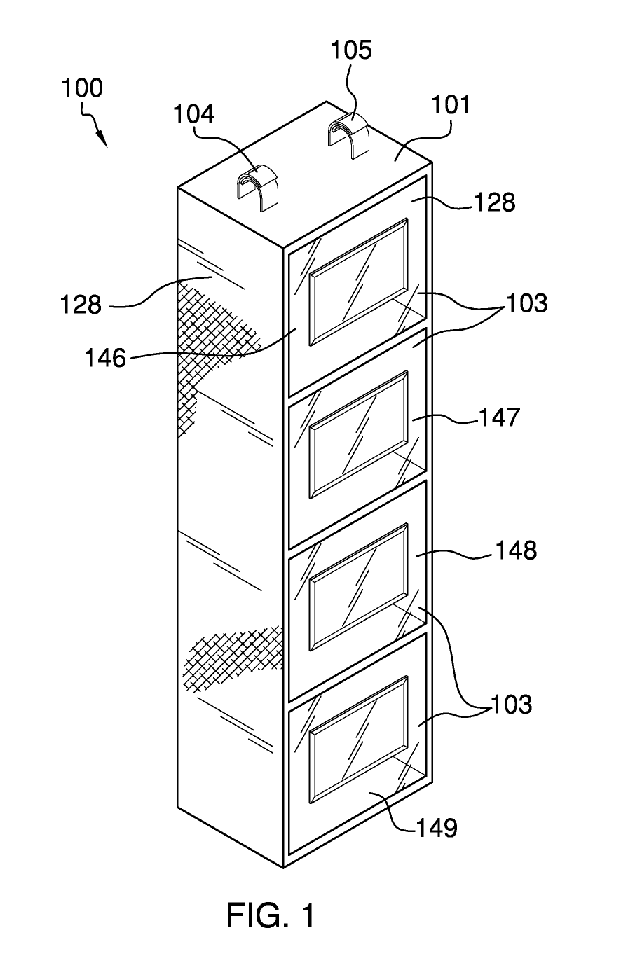

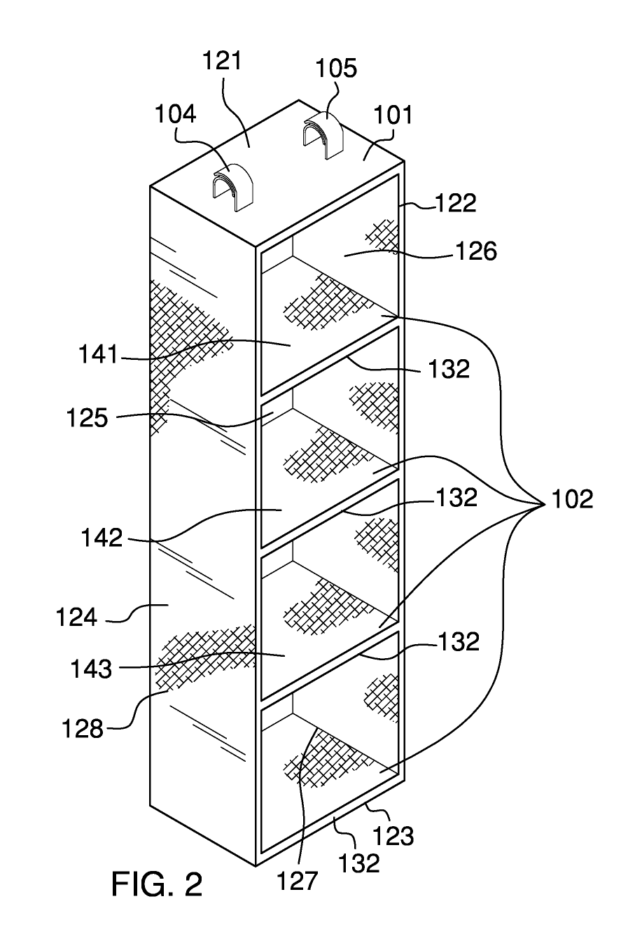

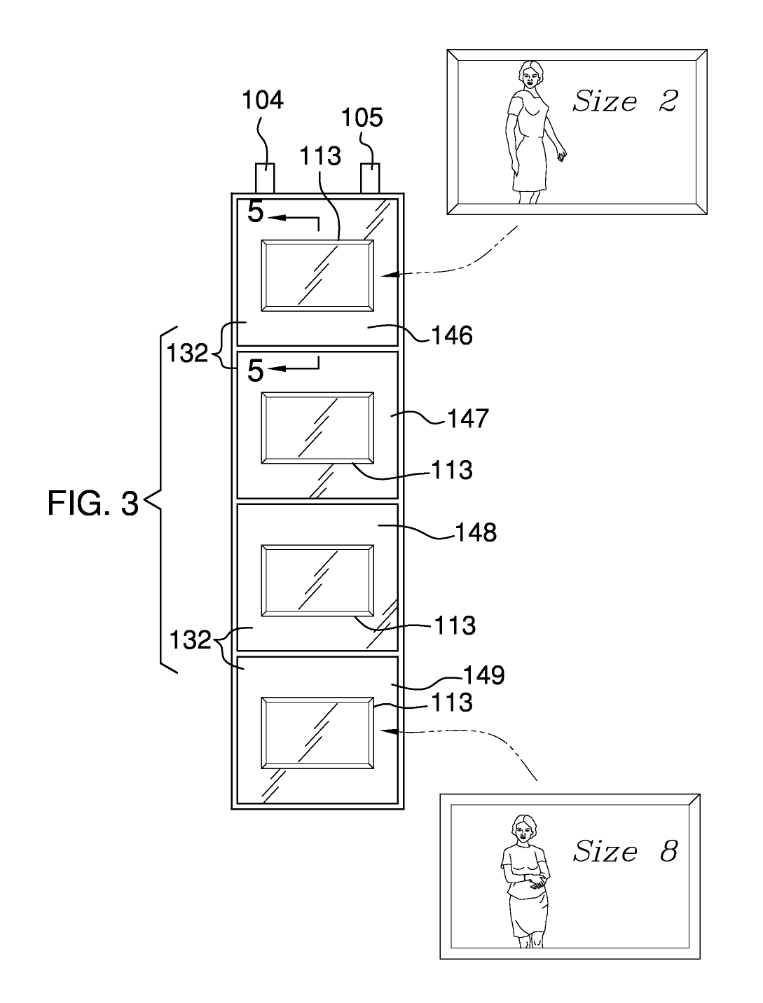

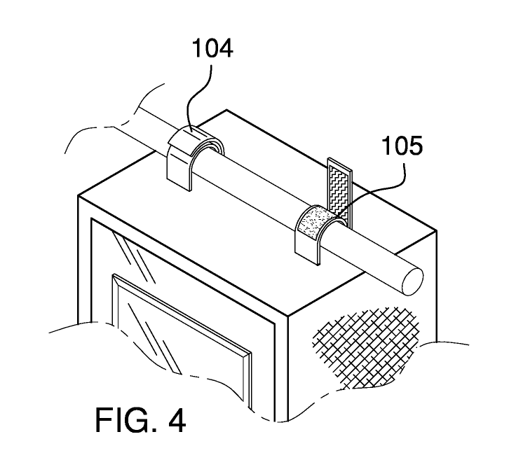

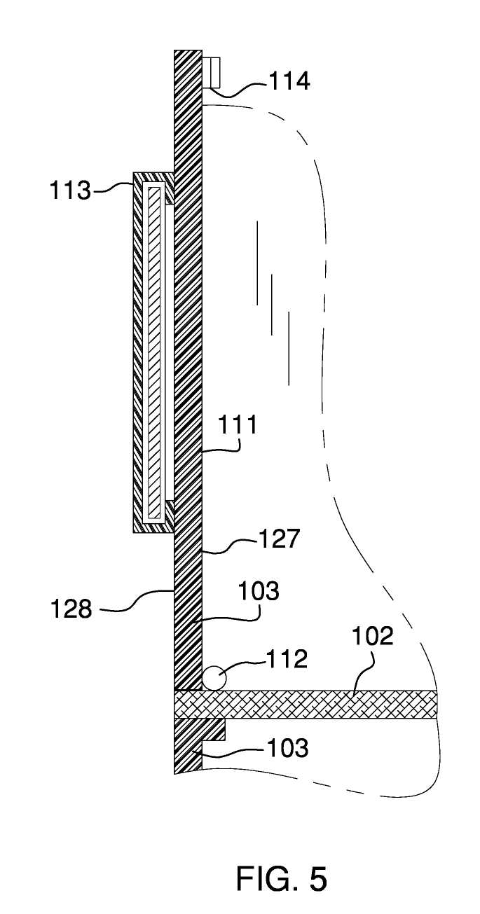

Detailed reference will now be made to a first potential embodiment of the disclosure, which is illustrated in FIGS. 1 through 5. The transparent garment receptacle 100 (hereinafter invention) comprises a shell 101, a plurality of shelves 102, a plurality of doors 103, a first fastener 104, and a second fastener 105.

The shell 101 is a structure formed in the shape of a rectangular block. The shell 101 is formed from a transparent material. The shell 101 is further defined with a first side 121, a second side 122, a third side 123, a fourth side 124, a fifth side 125, a sixth side 126, an interior 127 and exterior 128. The first side 121 of the shell 101 has the first fastener 104 and the second fastener 105 attached to it. The sixth side 126 has the plurality of doors 103 attached to it. The fifth side 125 is distal from the sixth side 126. When viewed from the sixth side 126 the remaining sides, in clockwise order from the first side 121, are the second side 122, the third side 123 and the fourth side 124. In the first potential embodiment of the disclosure, the fifth side 125 and the sixth side 126 of the shell 101 are open. In alternate potential embodiments of the disclosure, the fifth side 125 can be closed using a sheeting or other surface.

The first fastener 104 and the second fastener 105 are used to attach the invention 100 to a hanger rod in a closet so that the invention 100 can hang in the closet. Methods to select and attach fasteners to shells are well known and documented in the art.

The plurality of shelves 102 comprises a collection of individual shelves 132. Each individual shelf 132 is a horizontal surface that is mounted in the interior 127 of the shell 101 for the purpose of storing objects such as clothing. Each individual shelf 132 is made from a transparent material. For the purposes of this disclosure, the third side 123 of the shell 101 is considered an individual shelf 132 and is included as one of the plurality of shelves 102. Each individual shelf 132 is made of the same material as the shell 101. Methods to mount individual shelves 132 in a cabinet or shell 101 are well known and documented in the art. The first potential embodiment of the disclosure further comprises a first shelf 141, a second shelf 142, and a third shelf 143. The third side 123 acts as a fourth shelf.

The plurality of doors 103 comprises a collection of individual doors 133. Each individual door 133 further comprises a panel 111, a hinge 112, a picture frame 113, and a third fastener 114. The panel 111 is a flat rectangular surface that is sized to cover the open space of the sixth side 126 that exists between: 1) a first individual shelf 132 selected from the plurality of shelves 102 and a second individual shelf 132 selected from the plurality of shelves 102 that is adjacent to the first individual shelf 132; or, 2) the open space between the first shelf 141 and the first side 121. The hinge 112 is used to attach each individual door 133 to its corresponding individual shelf 132. The individual door 133 is attached to the individual shelf 132 such that the individual door 133 rotates into the closed position such that the direction of rotation is towards the first side 121. The third fastener 114 is a fastener that is used to keep the individual door 133 closed. A first portion of the third fastener 114 is attached to the interior 127 surface of the panel 111 and the second portion of the third fastener 114 is attached to either: 1) the adjacent individual shelf 132 that is proximal to the first side 121 of the invention 100; or, 2) the adjacent individual door 133 that is proximal to the first side 121 of the invention 100; or failing these first two options, 3) the first side 121 of the invention 100. The picture frame 113 attaches to the exterior 128 surface of the panel 111. The picture frame 113 is a framework within which a photograph or other picture can be mounted for display.

In the first potential embodiment of the disclosure, the plurality of shelves 102 further comprises a first shelf 141, a second shelf 142, and a third shelf 143. The third side 123 acts as a fourth shelf. The plurality of doors 103 further comprises a first door 146, a second door 147, a third door 148 and a fourth door 149. The panel 111 for each of the plurality of doors 103 is a rigid translucent structure. The hinge 112 for each of the plurality of doors 103 is a commercially available hinge hardware. The panel 111 of the first door 146 is attached to the first shelf 141 using the hinge 112 associated with the first door 146. The third fastener 114 associated with the first door 146 is a hook and loop fastener that is used to attach the panel 111 of the first door 146 to the first side 121. The panel 111 of the second door 147 is attached to the second shelf 142 using the hinge 112 associated with the second door 147. The third fastener 114 associated with the second door 147 is a hook and loop fastener that is used to attach the panel 111 of the second door 147 to the first shelf 141. The panel 111 of the third door 148 is attached to the third shelf 143 using the hinge 112 associated with the third door 148. The third fastener 114 associated with the third door 148 is a hook and loop fastener that is used to attach the panel 111 of the third door 148 to the second shelf 142. The panel 111 of the fourth door 149 is attached to the third side 123 using the hinge 112 associated with the fourth door 149. The third fastener 114 associated with the fourth door 149 is a hook and loop fastener that is used to attach the panel 111 of the fourth door 149 to the third shelf 143. The picture frame 113 is a rigid structure that is attached to the exterior 128 side of the panel 111 of each individual door 133.

In a second potential embodiment of the disclosure, the plurality of shelves 102 further comprises a first shelf 141, a second shelf 142, and a third shelf 143. The third side 123 acts as a fourth shelf. The plurality of doors 103 further comprises a first door 146, a second door 147, a third door 148 and a fourth door 149. The panel 111 for each of the plurality of doors 103 is a translucent vinyl structure. The hinge 112 for each of the plurality of doors 103 was formed as a glued seam that attached each individual door 133 to its associated individual shelf 132. The flexible nature of the translucent vinyl structure then allowed each individual door 133 to rotate around the pivot point formed by the glued seam.

The panel 111 of the first door 146 is attached to the first shelf 141 using a glued seam as the hinge 112 associated with the first door 146. The third fastener 114 associated with the first door 146 is a hook and loop fastener that is used to attach the panel 111 of the first door 146 to the first side 121. The panel 111 of the second door 147 is attached to the second shelf 142 using a glued seam as the hinge 112 associated with the second door 147. The third fastener 114 associated with the second door 147 is a hook and loop fastener that is used to attach the panel 111 of the second door 147 to the exterior 128 side of the panel 111 the first door 146. The panel 111 of the third door 148 is attached to the third shelf 143 using a glued seam as the hinge 112 associated with the third door 148. The third fastener 114 associated with the third door 148 is a hook and loop fastener that is used to attach the panel 111 of the third door 148 to the exterior 128 side of the panel 111 the second door 147.

The panel 111 of the fourth door 149 is attached to the third side 123 using a glued seam as the hinge 112 associated with the fourth door 149. The third fastener 114 associated with the fourth door 149 is a hook and loop fastener that is used to attach the panel 111 of the fourth door 149 to the exterior 128 side of the panel 111 the third door 148. The picture frame 113 is a vinyl envelope that is attached to the exterior 128 of the panel 111 of each individual door 133.

The motivation for creating the first potential embodiment of the disclosure and the second potential embodiment of the disclosure is to use the invention 100 as a weight loss aid. In this regard, the shell 101, the plurality of shelves 102, and the plurality of doors 103 are made from a transparent plastic material to provide a visible motivation for weight loss by organizing clothing on each shelf selected from the plurality of shelves 102 by clothing size. Being able to see clothing sizes both larger and smaller than the current size worn by the user provides the dieter with the motivation to continue with their diet regimen. Similarly, the motivation for each picture frame 113 placed in a door selected from the plurality of doors 103, is to display before and after photographs of the user to document the progress being made through the diet regimen.

In the first potential embodiment of the disclosure, suitable plastics for the shell 101, the plurality of shelves 102, and the plurality of doors 103 include, but are not limited to, polycarbonate or poly(methyl methacrylic). The first fastener 104 and the second fastener 105 are commercially available hook and loop fasteners. The hinge 112 used to join an individual door 133 to an individual shelf 132 is commercially available. The hinge 112 attaches the individual door 133 to the individual shelf 132 the individual door 133 is associated with. Each individual door 133 is held closed using a commercially available hook and loop fastener. The hook and loop fastener attaches a first individual door 133 to a second individual door 133 immediately above the first individual door 133 or, failing that, to the first side 121 of the shelf.

The difference between the first potential embodiment of the disclosure and the second potential embodiment of the disclosure are the individual doors 133. In the second potential embodiment of the disclosure, each individual door 133 is formed from vinyl plastic sheeting. The individual door 133 is glued to the individual shelf 132 the door is associated with. Each individual door 133 is held closed using a commercially available hook and loop fastener. The hook and loop fastener attaches a first individual door 133 to a second individual door 133 immediately above the first individual door 133 or, failing that, to the first side 121 of the shelf.

The following definitions were used in this disclosure:

Fastener: As used in this disclosure, a fastener is a device that is used to join or affix two objects. Fasteners generally comprise a first part which is attached to the first object and a second part which is attached to the second object.

Hinge: As used in this disclosure, a hinge is a device that permits the turning, rotating, or pivoting of a first object relative to a second object.

Hook and Loop Fastener: As used in this disclosure, a hook and loop fastener is a fastener that comprises a hook surface and a loop surface. The hook surface comprises a plurality of minute hooks. The loop surface comprises a surface of uncut pile that acts like a plurality of loops. When the hook surface is applied to the loop surface, the plurality of minute hooks fasten to the plurality of loops securely fastening the hook surface to the loop surface. A note on usage: when fastening a two objects the hook surface of a hook and loop fastener will be placed on the first object and the matching loop surface of a hook and loop fastener will be placed on the second object without significant regard to which object of the two objects is the first object and which object of the two objects is the second object. When the hook surface of a hook or loop fastener or the loop surface of a hook and loop fastener is attached to an object this will simply be referred to as the “hook or loop surface” with the understanding that when the two objects are fastened together one of the two objects will have a hook surface and the remaining object will have the loop surface.

Sheeting: As used in this disclosure, sheeting is a material, such as cloth or plastic, in the form of a thin flexible layer or layers that is used to cover something.

With respect to the above description, it is to be realized that the optimum dimensional relationship for the various components of the invention described above and in FIGS. 1 through 5, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A garment receptacle comprising:
a shell, a plurality of shelves, a plurality of doors, a first fastener, and a second fastener;
wherein the garment receptacle is transparent;
wherein the plurality of shelves created a plurality of compartments within the garment receptacle;
wherein the garment receptacle is adapted to hang from a hanger rod of a closet;
wherein the garment receptacle is adapted to receive and display a plurality of photographs or images;
wherein the shell is a structure formed in the shape of a rectangular block;
wherein the shell is formed from a transparent material;
wherein the shell is further defined with a first side, a second side, a third side, a fourth side, a fifth side, a sixth side, an interior and exterior;
wherein the first fastener and the second fastener are attached to the first side of the shell;
wherein the plurality of doors is attached to the sixth side of the shell;
wherein the plurality of shelves comprises a collection of individual shelves;
wherein each individual shelf is a horizontal surface;
wherein each individual shelf is mounted in the interior of the shell;
wherein each individual shelf is made from a transparent material;
wherein the plurality of doors comprises a collection of individual doors;
wherein each individual door further comprises a panel, a hinge, a picture frame, and a third fastener;
wherein the third fastener further comprises a first portion and a second portion;
wherein the panel is a flat rectangular surface;
wherein the panel is sized to cover the open space of the sixth side of the shell that exists between a first individual shelf selected from the plurality of shelves and a second individual shelf selected from the plurality of shelves that is adjacent to the first individual shelf or the open space between the first shelf and the first side;
wherein the hinge attaches each individual door to a corresponding individual shelf;
wherein the individual door is attached to the individual shelf such that the individual door rotates into the closed position such that the direction of rotation is towards the first side of the shell;
wherein the third fastener is used to keep the individual door closed;
wherein the first portion of the third fastener is attached to the interior surface of the panel;
wherein the second portion of the third fastener is attached to either the adjacent individual shelf that is proximal to the first side, or, the adjacent individual door that is proximal to the first side, or the first side;
wherein the picture frame attaches to the exterior surface of the panel.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. The garment receptacle according to claim 1 wherein the plurality of shelves further comprises a first shelf, a second shelf, a third shelf, and the third side.

16. The garment receptacle according to claim 15 wherein the plurality of doors further comprises a first door, a second door, a third door and a fourth door.

17. The garment receptacle according to claim 16 wherein the panel for each of the plurality of doors is a rigid translucent structure.

18. The garment receptacle according to claim 17 wherein
the panel of the first door is attached to the first shelf using the hinge associated with the first door;
wherein the third fastener associated with the first door is a hook and loop fastener that is used to attach the panel of the first door to the first side;
wherein the panel of the second door is attached to the second shelf using the hinge associated with the second door;
wherein the third fastener associated with the second door is a hook and loop fastener that is used to attach the panel of the second door to the first shelf;
wherein the panel of the third door is attached to the third shelf using the hinge associated with the third door;
wherein the third fastener associated with the third door is a hook and loop fastener that is used to attach the panel of the third door to the second shelf;
wherein the panel of the fourth door is attached to the third side using the hinge associated with the fourth door;
wherein the third fastener associated with the fourth door is a hook and loop fastener that is used to attach the panel of the fourth door to the third shelf.

19. The garment receptacle according to claim 15 wherein the panel for each of the plurality of doors is a translucent vinyl structure.

20. The garment receptacle according to claim 19 wherein
the panel of the first door is attached to the first shelf using a glued seam;
wherein the third fastener associated with the first door is a hook and loop fastener that is used to attach the panel of the first door to the first side wherein the panel of the second door is attached to the second shelf using a glued seam;
wherein the third fastener associated with the second door is a hook and loop fastener that is used to attach the panel of the second door to the first shelf;
wherein the panel of the third door is attached to the third shelf using a glued seam;
wherein the third fastener associated with the third door is a hook and loop fastener that is used to attach the panel of the third door to the second shelf;
wherein the panel of the fourth door is attached to the third side using a glued seam;
wherein the third fastener associated with the fourth door is a hook and loop fastener that is used to attach the panel of the fourth door to the third shelf.
